(19) United States
(12) Patent Application Publication
(10) Pub. No.: US 2009/0087580 A1
(43) Pub. Date: Apr. 2, 2009

(54) INK COMPOSITION, PATTERN FORMATION METHOD AND DROPLET DISCHARGE DEVICE

(75) Inventors: Hirotsuna MIURA, Fujimi (JP); Hidekazu MORIYAMA, Fujimi (JP); Naoyuki TOYODA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/204,104

(22) Filed: Sep. 4, 2008

(30) Foreign Application Priority Data
Sep. 27, 2007 (JP) 2007-250787

(51) Int. Cl. B05D 5/12; C09D 11/00; H01B 1/00; B05B 1/00; B05D 3/06

(52) U.S. Cl. 427/542; 106/31.92; 427/596; 252/500; 118/642

(57) ABSTRACT

An ink composition includes a conductive fine particle, a dispersion medium in which the conductive fine particle is dispersed, and a combustion substance that starts a combustion reaction by receiving light.

### BACKGROUND OF THE INVENTION

1. Technical Field

The present invention relates to an ink composition, a pattern formation method and a droplet discharge device.

2. Related Art

A multilayer substrate made of low temperature co-fired ceramics (LTCC) has excellent high-frequency characteristics and high heat resistance, and therefore is widely used for, e.g., substrates of high-frequency modules and substrates of IC packages.

Used in a method for manufacturing an LTCC multilayer substrate are a process of drawing a circuit pattern on a green sheet by the use of metal ink and a process of laminating a plurality of green sheets and collectively firing the circuit patterns and green sheets.

Regarding the process of drawing a circuit pattern, a so-called inkjet method of discharging minute droplets of metal ink is proposed in order to achieve high density of circuit patterns (e.g., JP-A-2005-57139).

The inkjet method draws a circuit pattern using a large number of droplets each ranging from several to several ten picoliters in volume, and changes the discharging position of the droplets, thereby enabling the circuit pattern to be made fine and the pitch to be made narrow.

When this circuit pattern made of the droplets is dried by a drying oven, the whole of a green sheet is subjected to heat treatment, resulting in increased thermal deformation.

With the inkjet method, proposals to solve the foregoing problem have been made heretofore.

In JP-A-2006-247529, JP-A-2006-248189 and JP-A-2006-247622, a droplet discharge head, each discharging droplets, is provided with laser sources, and discharged droplets are each irradiated with laser light, so that each droplet is dried in a moment.

Laser light emitted by the laser sources supplies required amount of heat only to areas of droplets.

This allows thermal damages to a circuit pattern and a green sheet to be significantly reduced.

In the inkjet method, an object and a droplet discharge head are relatively moved in order to draw a circuit pattern in a desired shape.

The relative movement of an object and a droplet discharge head, i.e., the relative movement of a droplet and laser light causes the droplet on the object to leave an area of laser light in a moment.

This remarkably reduces irradiation time during which the droplet on the object is irradiated with the laser light.

In the droplet discharge head, a pitch at which nozzles are formed is several ten to several hundred μm.

Accordingly, if laser light is applied separately to each nozzle, the spot size of the laser light is reduced to the same size as that of a pitch for forming nozzles.

This reduced laser light spot further reduces irradiation time during which the droplet on the object is irradiated with the laser light.

As a result, one problem with a droplet drying method using laser light arises that makes it difficult to obtain sufficient irradiation time for drying droplets, leading to insufficient drying of droplets.

It is considered that such a problem can be solved by increasing output of a laser to compensate for the reduction of irradiation time.

However, if all energy required for drying is applied to a droplet for a short time, this easily leads to sudden boiling of the droplet, thus eliminating a pattern.

### SUMMARY

An advantage of the present invention is to provide an ink composition with improved drying efficiency, a pattern formation method using this ink composition, and a droplet discharge device.

An ink composition according to a first aspect of the invention includes a conductive fine particle, a dispersion medium in which the conductive fine particle is dispersed, and a combustion substance that starts a combustion reaction by receiving light.

The ink composition according to this aspect of the invention causes the combustion substance to start a combustion reaction by receiving light.

The heat generated by this combustion reaction can accelerate the drying of the ink composition.

Thus, the ink composition according to this aspect of the invention allows improvement of drying efficiency of a droplet made of the ink composition.

Regarding this ink composition, it is preferable that the light be infrared laser light, the combustion substance be an agglomerate of a coloring matter containing oxygen, and the coloring matter start a combustion reaction with the oxygen by receiving the infrared laser light.

In this case, the ink composition allows its drying to be accelerated by heat generated by the combustion reaction of the coloring matter.

Regarding this ink composition, it is preferable that the light be laser light, and the combustion substance have a self-combustion substance that starts a self-combustion reaction by receiving the laser light.

In this case, the ink composition allows its drying to be accelerated by heat generated by a self-combustion reaction of the self-combustion substance.

Regarding this ink composition, it is preferable that the light be infrared laser light, and the combustion substance have a microcapsule containing a coloring matter that converts the infrared laser to heat and a self-combustion substance that starts a self-combustion reaction by receiving heat from the coloring matter.

In this case of the ink composition, the self-combustion substance is a microcapsule, and therefore restrictions on the conductive fine particle, the dispersion medium, the coloring matter and the self-combustion substance can be reduced.

Regarding this ink composition, it is preferable that the dispersion medium have any one organic matter selected from a group including alcohols, glycols and ethers that start a combustion reaction by heat generated by the combustion reaction of the combustion substance.

In this case of the ink composition, only once combustion of the combustion substance is performed, combustion of a water-soluble organic matter contained in the dispersion medium can be performed in a chained manner.

Thus, this ink composition allows drying of the dispersion medium to be accelerated with reliability regardless of irradiation time of the light.

A pattern formation method according to a second aspect of the invention includes discharging an ink composition, which includes a conductive fine particle, a dispersion medium, and a combustion substance that starts a combustion reaction by receiving light, as a droplet to an object, and applying light to the droplet to cause the combustion substance to start a combustion reaction, thereby drying the droplet to form a conductive pattern on the object.

The pattern formation method according to this aspect of the invention includes applying light to a droplet containing a combustion substance, so that drying of the droplet can be accelerated by the heat of a combustion reaction of the combustion substance.

Therefore, the pattern formation method according to this aspect of the invention allows improvement of drying efficiency of a droplet made of an ink composition, leading to achievement of a fine pattern.

It is preferable that this pattern formation method apply light to the droplet before landing on the object, causing the combustion substance to start a combustion reaction.

In this case, the pattern formation method causes the droplet before landing on the object to start a combustion reaction, i.e., drying treatment.

Thus, this pattern formation method can cope with finer design rules regarding a conductive pattern.

A droplet discharge device according to a third aspect of the invention includes an ink tank, a droplet discharge head and an irradiation portion.

The ink tank stores an ink composition including a conductive fine particle, a dispersion medium and a combustion substance that starts a combustion reaction by receiving light.

The droplet discharge head receives the ink composition derived from the ink tank and discharges the ink composition as a droplet to an object.

The irradiation portion applies the light to the droplet.

Regarding the droplet discharge device according to this aspect of the invention, a droplet discharged from the droplet discharge head is irradiated with light.

This allows drying of the droplet to be accelerated by heat caused by combustion of the combustion substance contained in the droplet.

Thus, the droplet discharge device according to this aspect of the invention can improve the drying efficiency of the droplet.

In this droplet discharge device, it is preferable that the irradiation portion apply light to the droplet before landing on the object.

In this case, the droplet discharge device allows the droplet before landing on the object to start a combustion reaction, i.e., drying treatment.

Thus, this droplet discharge device can improve the drying efficiency of the droplet with more reliability, and cope with finer design rules regarding a pattern made of conductive fine particles.

### BRIEF DESCRIPTION OF THE DRAWINGS

The invention will be described with reference to the accompanying drawings, wherein like numbers reference like elements.

FIG. 1 is a perspective view showing a droplet discharge device.

FIG. 2 is a perspective view showing a droplet discharge head.

FIGS. 3A and 3B are a side sectional view showing the droplet discharge head and a plan view schematically showing droplet discharge operations, respectively.

FIGS. 4A to 4C each schematically show drying treatment.

FIG. 5 is an electrical block circuit diagram showing the electrical configuration of the droplet discharge device.

FIG. 6 is an electrical block circuit diagram showing the electrical configuration of a head drive circuit.

FIGS. 7A to 7C each schematically show drying treatment of a second embodiment.

FIGS. 8A to 8C each schematically show drying treatment of a third embodiment.

FIGS. 9A and 9B are a side sectional view showing a droplet discharge head and a plan view schematically showing droplet discharge operations, respectively, of a fourth embodiment.

### DESCRIPTION OF EXEMPLARY EMBODIMENTS

Embodiments of the invention will be described.

### First Embodiment

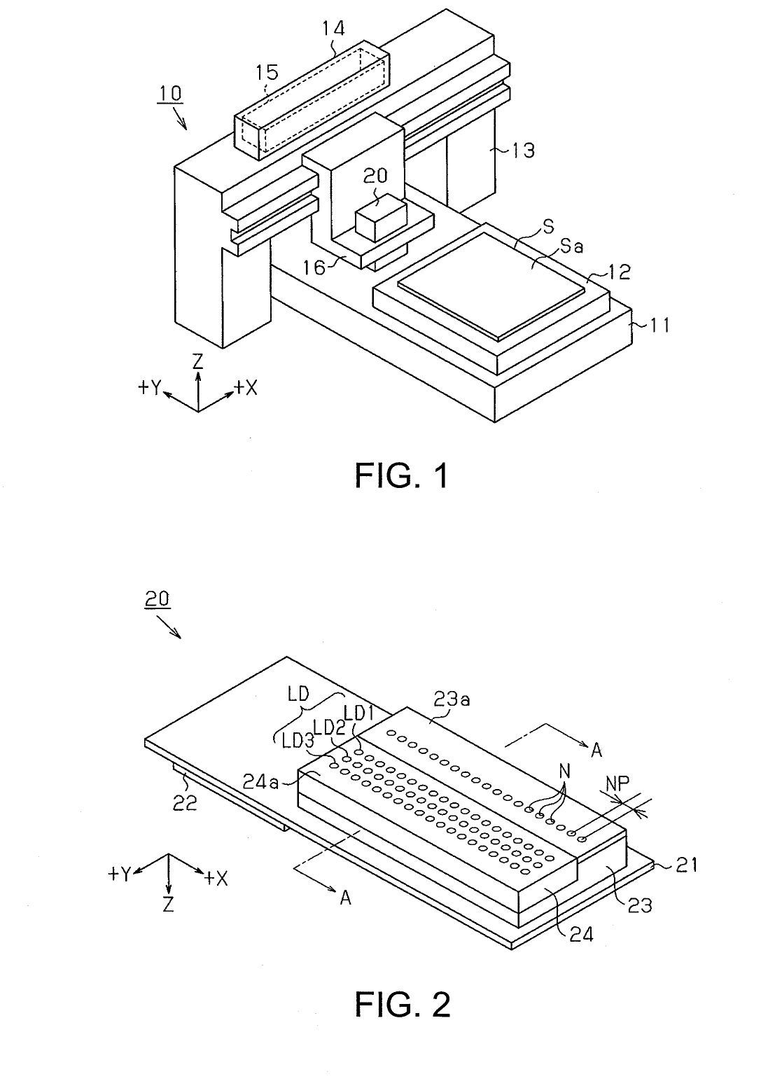

A first embodiment that gives a concrete form to the invention will be described below referring to FIGS. 1 to 6.

FIG. 1 is a perspective view showing the whole of a droplet discharge device 10.

In FIG. 1, the droplet discharge device 10 includes a stage 12 for mounting a substrate S thereon on a base 11 extending in one direction.

The stage 12 positions and fixes the substrate S with one surface thereof turned upward and transports the substrate S along the longitudinal direction of the base 11.

As the substrate S, various substrates such as a green sheet, a glass substrate, a silicon substrate, a ceramic substrate, a resin film and paper are used.

In the present embodiment, the top surface of the substrate S is referred to as a “discharge surface Sa”.

A direction along which the substrate S is transported and that is toward the upper left in FIG. 1 is referred to as a “+Y direction”.

A direction that is orthogonal to the +Y direction and that is toward the upper right in FIG. 1 is referred to as a “+X direction”, and a direction normal to the substrate S is referred to as a “Z direction”.

The droplet discharge device 10 has an ink tank 14 disposed on the upper side of a gate type guide member 13 straddling the base 11.

The ink tank 14 stores conductive ink 15 as an ink composition, and discharges the stored conductive ink 15 at a predetermined pressure.

Attached to the guide member 13 is a carriage 16 that is movable along the +X direction and its opposite direction (−X direction).

The carriage 16 with a droplet discharge head 20 mounted thereon moves in the +X direction or the −X direction to place the droplet discharge head 20 to a desired position.

Note that an operation of transporting the substrate S in the +Y direction is referred to as “main scanning”, and an operation of transporting the droplet discharge head 20 in the +X direction and the −X direction is referred to as “sub-scanning”.

FIG. 2 is a perspective view of the droplet discharge head 20 as seen from the stage 12.

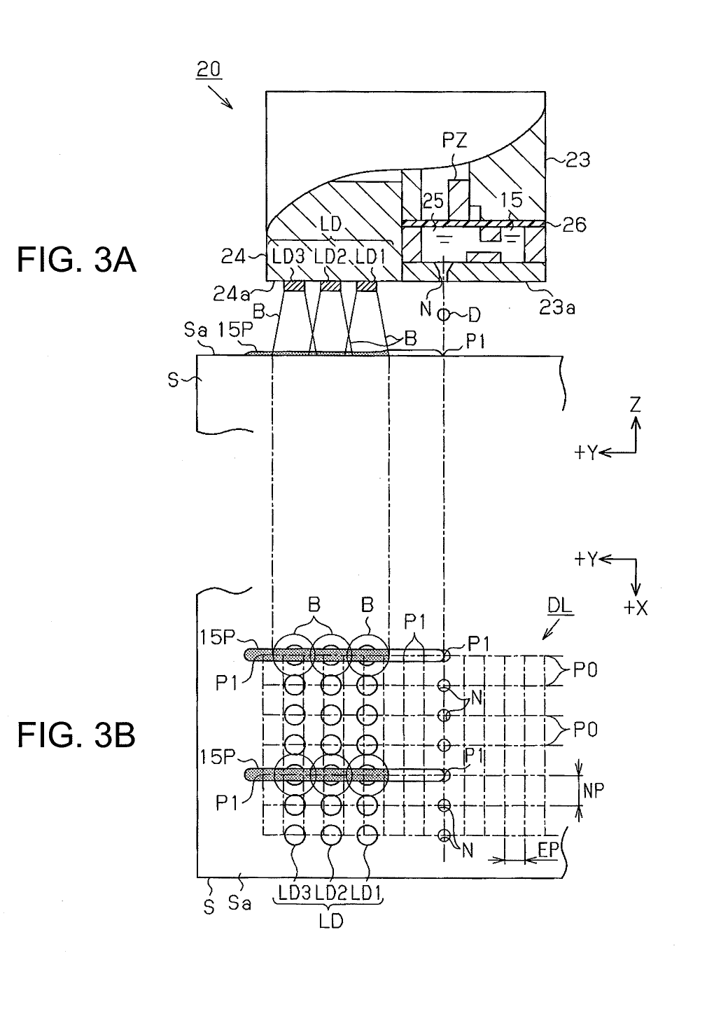

FIG. 3A is a sectional view taken along the line A-A of FIG. 2, and shows droplet discharge operations of the droplet discharge head 20.

FIG. 3B is a plan view of the droplet discharge head 20 as seen from the discharge surface Sa.

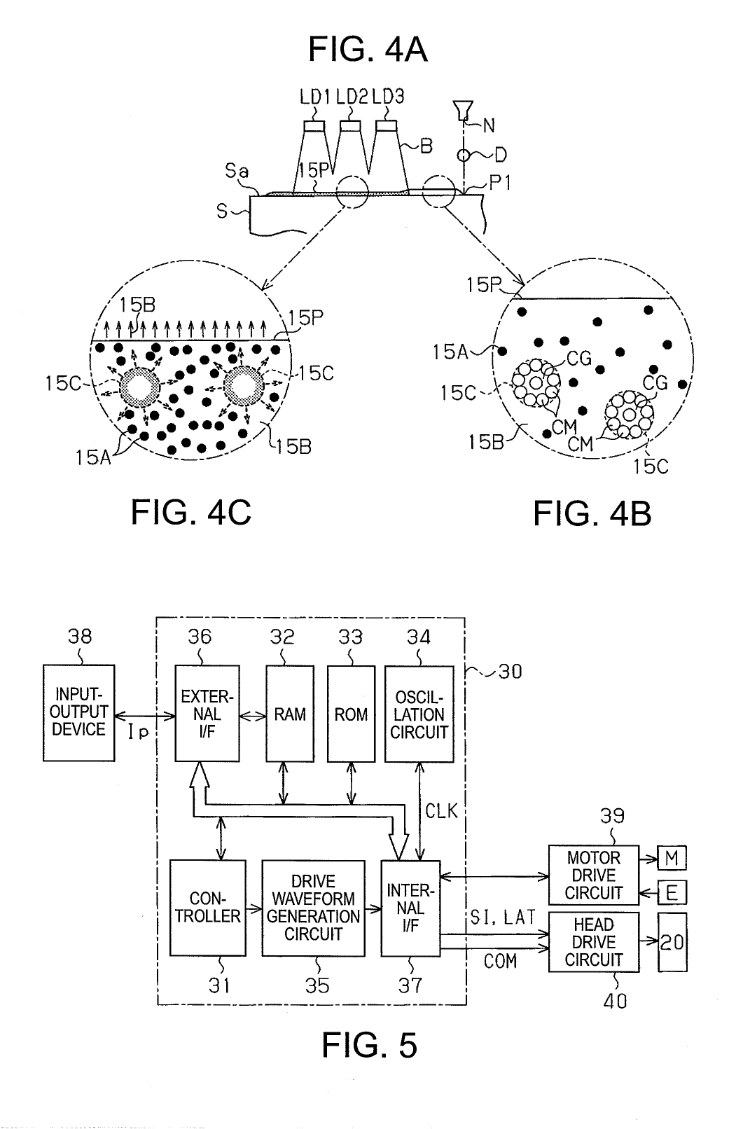

FIGS. 4A to 4C are process drawings each showing a drying process of the droplet D.

In FIG. 2, the droplet discharge head 20 has an input terminal 22 provided in one end of a head substrate 21 extending in the +X direction, and a head body 23 supported by the head substrate 21.

The input terminal 22 receives drive signals from the outside and outputs the drive signals to the head body 23.

The head body 23 has i (i is an integer of one or more) nozzles N over substantially the whole width in the +X direction of a surface facing the substrate S (hereinafter referred to simply as a “nozzle formation surface 23a”).

Each nozzle N is formed in such a manner as to pass through the nozzle formation surface 23a along the Z direction, and is aligned along the +X direction at a predetermined pitch (hereinafter referred to simply as a “nozzle pitch NP”).

For example, 180 nozzles N are formed at a pitch of 141 μm along the +X direction on the nozzle formation surface 23a.

In FIG. 3A, the head body 23 has cavities 25 each positioned above each nozzle N, and has vibration plates 26 and piezoelectric elements PZ each positioned above each cavity 25.

Each cavity 25 is connected to the common ink tank 14, and contains the conductive ink 15 from the ink tank 14 and supplies the conductive ink 15 to the nozzle N communicated with the cavity 25.

Each vibration plate 26 vibrates in the Z direction to expand and contract the volume of the cavity 25 thereby to vibrate meniscus of the nozzle N communicated with the cavity 25.

Each piezoelectric element PZ receives drive signals, and shrinks and extends in the Z direction to vibrate the vibration plate 26 in the Z direction.

Each cavity 25 discharges a meniscus of the conductive ink 15 as the droplet D when the corresponding vibration plate 26 vibrates in the Z direction.

For example, the head body 23 discharges the conductive ink 15 from the ink tank 14 as the droplets D each having a weight of 10 ng.

In FIG. 3B, the discharge surface Sa is virtually divided by a dot pattern lattice DL indicated by alternate long and short dash lines.

The dot pattern lattice DL is a lattice in which a lattice interval in the +Y direction and a lattice interval in the +X direction are each made of a discharge interval of the droplets D.

For example, in the dot pattern lattice DL, lattice points P0 in the +Y direction are equally distributed using the product of a period of discharging the droplet D and a speed of main scanning (hereinafter referred to simply as a “discharge pitch EP”), and lattice points P0 in the +X direction are equally distributed at the nozzle pitch NP.

Whether the droplet D is discharged or not is selected for each lattice point P of the dot pattern lattice DL.

In the embodiment, the lattice point P0 for which a discharge operation of the droplet D is selected is referred to as a “target point P1”.

When discharging of the droplet D is performed, one nozzle N that is common to a group of lattice points P0 aligned in the +Y direction is set above the group of lattice points P0.

The group of lattice points P0 aligned in the +Y direction each passes directly under one common nozzle N by main scanning of the substrate S.

When the target point P1 is positioned directly under the nozzle N, the piezoelectric element PZ corresponding to the nozzle N receives drive signals from the input terminal 22 and discharges the droplet D from the nozzle N.

The droplet D discharged from the nozzle N lands on the lattice point P0 facing the nozzle N, i.e., the target point P1.

The droplet D that has landed on each target point P1 wets and spreads along the surface direction of the discharge surface Sa to become united with the adjacent droplet D, thereby forming a continuous liquid pattern 15P.

For example, if a group of lattice points P0 aligned in the +Y direction are selected as the target points P1, the droplets D landing on the target points P1 form the strip-like liquid pattern 15P extending along the +Y direction as shown in FIG. 3B.

Note that the dried liquid pattern 15P is designated by gradation in FIG. 3B.

In FIG. 2, a laser plate 24 is mounted on the bottom surface of the droplet discharge head 20 in the +Y direction of the nozzles N.

The laser plate 24 has laser sources LD as a plurality of irradiation portions over substantially the whole width in the +X arrow direction of the bottom surface (hereinafter referred to simply as a “laser arrangement surface 24a”).

Just j (j is an integer of two or more) laser sources LD are aligned in the +Y direction of each nozzle N to form a laser array made of i×j laser sources over substantially the whole of the laser arrangement surface 24a.

For example, the laser plate 24 has three laser sources LD aligned in the +Y direction of each nozzle N at a pitch of 50 μm to form a laser array of 180×3 laser sources.

In FIG. 2, a reduced number of laser sources LD is shown for ease of explanation of their arrangement positions.

In the embodiment, the laser sources LD, in order from the laser source LD nearest to the nozzle N among j laser sources LD, are referred to as a “first laser source LD1”, a “second laser source LD2” and a “third laser source LD3”.

Each laser source LD applies laser light in the near infrared region having a wavelength of 800 to 1200 nm (hereinafter referred to simply as a “infrared laser light B”) toward the discharge surface Sa at predetermined energy.

As the laser source LD, for example, a vertical cavity surface emitting laser (VCSEL) having an emitting surface that is substantially parallel to the discharge surface Sa can be used.

With this VCSEL, the thickness in the Z direction of each laser source LD is sufficiently thin as compared to a platen gap, allowing each laser source LD to be attached without enlarging the platen gap.

In FIGS. 3A and 3B, when each laser source LD has received predetermined drive signals, the laser source LD applies the infrared laser light B to an area of the discharge surface Sa positioned directly thereunder.

When discharging of the droplets D is performed, the droplets D landing on target points P1 each pass directly under the laser sources LD in order of the first laser source LD1, the second laser source LD2 and the third laser source LD3 by main scanning of the substrate S.

In FIGS. 4A to 4C, the droplet D (i.e., the conductive ink 15) has conductive fine particles 15A, a dispersion medium 15B the main component of which is water, and combustion substances 15C (refer to FIG. 4B).

As an example of the conductive fine particle 15A, metals such as gold, silver, copper, platinum, palladium, rhodium, osmium, ruthenium, iridium, iron, tin, cobalt, nickel, chromium, titanium, tantalum, tungsten and indium or alloys of these metals can be used.

In particular, silver and copper are preferably used.

The size and shape of the conductive fine particle 15A are not limited, but a fine particle having a particle size ranging from several to several ten nanometers is preferably used.

The use of a fine particle having such a size allows baking temperature of the conductive ink 15 to be decreased.

This allows the dispersibility of the conductive fine particle 15A and flowability of the conductive ink 15 to be improved, leading to stabilization of discharge operations of the conductive ink 15.

As the dispersion medium 15B, water or an aqueous solution the main component of which is water can be used.

The dispersion medium 15B may have a water-soluble organic solvent as needed in order to adjust the viscosity of the conductive ink 15.

Examples of the water-soluble organic solvent can include alkyl alcohols such as ethanol, methanol, butanol, propanol and isopropanol; glycols such as ethylene glycol, propylene glycol, diethylene glycol and triethylene glycol; and glycol ethers such as ethylene glycol monomethyl ether, ethylene glycol monoethyl ether, ethylene glycol monobutyl ether, ethylene glycol monomethyl ether acetate, propylene glycol monomethyl ether and propylene glycol monoethyl ether.

These materials may be used in combination.

As the combustion substance 15C, an agglomerate of coloring matters that contains oxygen gas CG in its inside can be used.

The coloring matters in this case have their absorption maximums in the near infrared region with a wavelength of 800 to 1200 nm (hereinafter referred to simply as a “infrared absorption coloring matter CM”).

Examples of the infrared absorption coloring matter CM can include phthalocyanine, naphthalocyanine, azo, polymethine, anthraquinone, naphthoquinone, pyrylium, thiopyrilium, squarylium, croconium, tetradehydrocholine, triphenylmethane, cyanine, azo and aminium compounds.

These compounds may be used in combination.

This combustion substance 15C is obtained e.g., as follows: when the infrared absorption coloring matters CM are dispersed into the dispersion medium 15B, the oxygen gas CG in the air is mixed in the infrared absorption coloring matters CM to adjust the dispersibility of the infrared absorption coloring matters CM.

Note that the conductive ink 15 may contain a dispersing agent to disperse the conductive fine particles 15A into the dispersion medium 15B, water-soluble polyhydric alcohol for moisture retention of the conductive ink 15 and the like.

The dispersing agent needs only to be one that easily dissolves in water and that coordinates to the conductive fine particle 15A to stabilize the colloidal state of the conductive fine particle 15A.

As an example of the dispersing agent, hydroxy acid having a carboxyl group and a hydroxyl group as the functional group or a hydroxy acid salt may be used.

Examples of the hydroxy acid include citric acid, malic acid and tartaric acid, and these materials may be used in combination.

Examples of the hydroxy acid salt include sodium citrate, potassium citrate, lithium citrate, sodium malate and sodium tartrate, and these materials may be used in combination.

As the foregoing dispersing agent, mercapto acid having a carboxyl group and a mercapto group as the functional group, or a mercapto acid salt may be used.

Examples of mercapto acid include mercaptoacetic acid, mercaptopropionic acid, mercaptobutanoic acid and mercaptosuccinic acid, and these materials may be used in combination.

Examples of mercapto acid salt can include sodium mercaptoacetate, mercaptopropionic acid soium salt and sodium mercaptosuccinate, and these materials may be used in combination.

As the foregoing polyhydric alcohol, alcohol with a valence of three to six that is solid under the standard conditions (25° C., normal atmospheric pressure) can be used.

As the foregoing polyhydric alcohol, sugar alcohols produced by reducing the carbonyl group of monosaccharides, disaccharides, oligosaccharide and polysaccharides, 2-(hydroxymethyl)-1,3-propanediol, 1,2,3-hexanetriol, 1,2,3-heptanetriol and the like can be used.

Examples of the sugar alcohols can include pentaerythritol, dipentaerythritol, tripentaerythritol, sorbitol, erythritol, threitol, ribitol, arabinitol, xylitol, allitol, mannitol, dulcytol, iditol, glycol, inocytol, maltitol and lactitol, and these materials may be used in combination.

In FIGS. 4A to 4C, when each laser source LD has received drive signals, the laser source LD applies the infrared laser light B to an area of the discharge surface Sa positioned directly thereunder.

Each droplet D landing on the target point P1 passes directly under the laser sources LD in order of the first laser source LD1, the second laser source LD2 and the third laser source LD3 by main scanning of the substrate S.

At this point, the combustion substance 15C of the droplet D receives the infrared laser light B from each laser source LD, causing its infrared absorption coloring matter CM and the oxygen gas CG contained in the agglomerate to start a combustion reaction.

Part of heat generated by the combustion reaction is converted to kinetic energy of the dispersion medium 15B to accelerate drying of the dispersion medium 15B.

Part of heat generated by the combustion reaction also causes a water-soluble organic matter such as alcohols, glycols and ethers contained in the dispersion medium 15B and the oxygen gas CG to start a combustion reaction in a chained manner.

This chain of combustions consecutively accelerates drying of the dispersion medium 15B.

For example, in the case where the dispersion medium 15B of the conductive ink 15 contains water of 40 wt. % and a water-soluble organic matter (glycerin and xylitol) of 10 wt. % with respect to the whole of the conductive ink 15, heat of about 10 μJ per drop is required to evaporate all the water contained in the droplet D of 10 ng.

On the other hand, a water-soluble organic matter such as alcohols, glycols and ethers contained in the droplet D generates heat of about 20 μJ by combustion of the water-soluble organic matter.

Therefore, regarding the droplet D, heat generated by the combustion reaction of the combustion substance 15C causes the water-soluble organic matter to start a combustion reaction in a chained manner, thereby enabling all the water to be continuously evaporated, so that drying is completed.

As a result of this, when the liquid pattern 15P passing directly under the laser source LD enters an area of the infrared laser light B, the combustion substance 15C starts a combustion reaction.

After the combustion of the combustion substance 15C has been completed, the liquid pattern 15P is consecutively dried due to a combustion reaction of the water-soluble organic matter that proceeds in a chained manner.

Therefore, the liquid pattern 15P is dried only once the combustion substance 15C starts a combustion reaction, regardless of time during which the liquid pattern 15P is irradiated with the infrared laser light B.

Thus, the wetting and spreading of the liquid pattern 15P can be sufficiently suppressed.

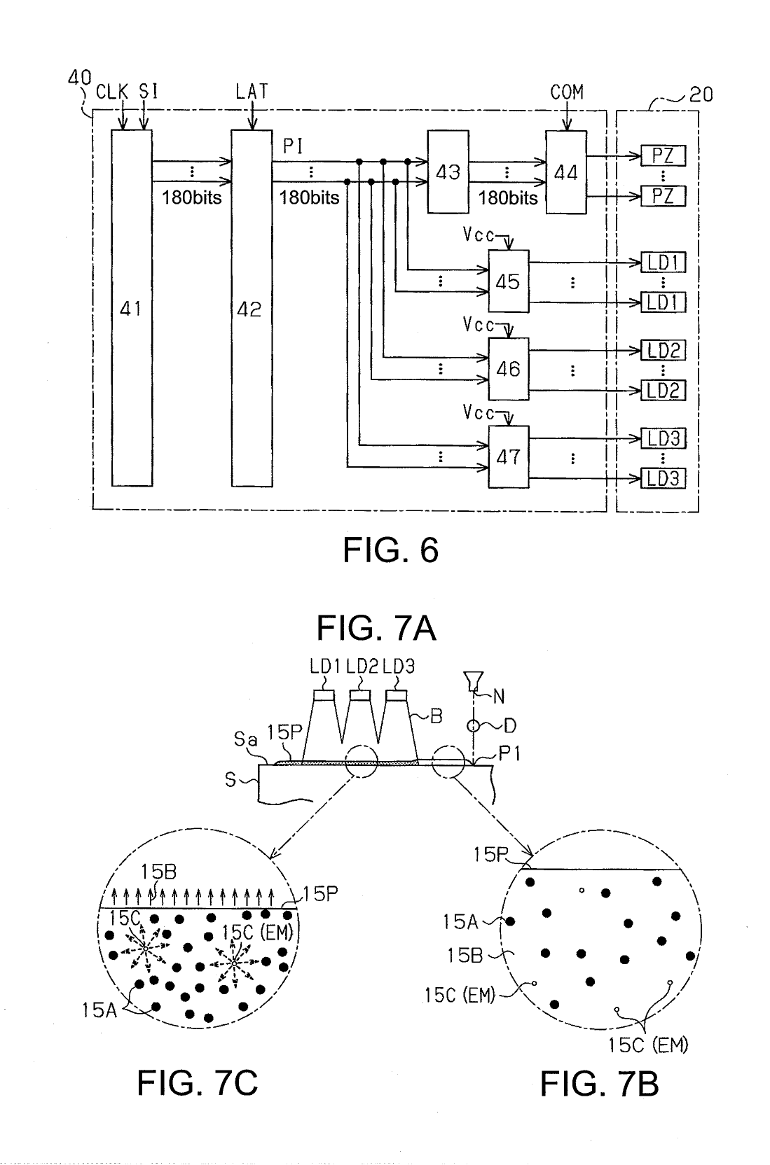

Next, electrical configuration of the droplet discharge device 10 will be described referring to FIGS. 5 and 6.

FIG. 5 is a block circuit diagram showing the electrical configuration of the droplet discharge device 10.

FIG. 6 is a block circuit diagram showing the electrical configuration of a head drive circuit.

In FIG. 5, a control device 30 includes a controller 31 having a central processing unit (CPU) and the like, a random access memory (RAM) 32 that includes a dynamic RAM (DRAM) and a static RAM (SRAM) and in which various data is stored, and a read only memory (ROM) 33 in which various control programs are stored.

The control device 30 includes an oscillation circuit 34 that generates clock signals, a drive waveform generation circuit 35 that generates drive waveform signals, an external interface (I/F) 36 that receives various signals, and an internal I/F 37 that transmits various signals, and causes the droplet discharge device 10 to perform various processing operations.

The control device 30 is connected through the external I/F 36 to an input-output device 38.

The control device 30 is connected through the internal I/F 37 to a motor drive circuit 39 and a head drive circuit 40.

The input-output device 38 is an external computer having, e.g., a CPU, a RAM, a ROM, a hard disk and a liquid crystal display.

The input-output device 38 outputs various control signals for driving the droplet discharge device 10 to the external I/F 36.

The external I/F 36 receives pattern data Ip for forming the liquid pattern 15P from the input-output device 38.

The term “pattern data Ip” means various data for discharging the droplet D, such as data on the speed of scanning of the substrate S, data on the period of discharging the droplet D and data on coordinates of the lattice point P0 and the target point P1.

The RAM 32 is used as a receive buffer, an intermediate buffer or an output buffer.

The ROM 33 stores various control routines to be executed by the controller 31 and various data for executing such control routines.

The oscillation circuit 34 generates clock signals for making various data and various drive signals in synchronization.

The oscillation circuit 34 generates a transmission clock CLK for serial transmission of, e.g., various data.

The oscillation circuit 34 generates, at a period of discharging the droplet D, timing signals LAT for parallel conversion of various data that has been serially transmitted.

The drive waveform generation circuit 35 stores waveform data for generating drive waveform signals COM such that the waveform data corresponds to a predetermined address.

The drive waveform generation circuit 35 latches the waveform data read by the controller 31 and converts the data into analog signals for every clock signals at a discharging period, and amplifies the analog signals to generate the drive waveform signals COM.

The external I/F 36 receives the pattern data Ip from the input-output device 38, temporarily stores it in the RAM 32, and converts it into intermediate codes.

The controller 31 reads the intermediate code data stored in the RAM 32 and generates dot pattern data.

The term “dot pattern data” means data that associates each lattice point P0 with whether or not the lattice point P0 is the target point P1.

The controller 31 generates dot pattern data corresponding to one main scanning, and then generates serial data synchronizing with the transmission clock CLK by the use of the generated dot pattern data and serially transmits the generated serial data through the internal I/F 37 to the head drive circuit 40.

In the embodiment, serial data generated using dot pattern data is referred to as “serial pattern data SI”.

The serial pattern data SI is data for associating the value of each bit defining discharge or non-discharge of the droplet D with each piezoelectric element PZ, and is generated at a period of discharging the droplet D.

The controller 31 is connected through the internal I/F to the motor drive circuit 39 and outputs drive control signals corresponding to the motor drive circuit 39.

The motor drive circuit 39 is connected to various motors M for moving the stage 12 and the carriage 16 and to an encoder EC for detecting the number of rotations and the rotating direction of the motors M.

The motor drive circuit 39 drives the motor M, in response to drive control signals from the controller 31, to perform sub-scanning using the carriage 16 and main scanning using the stage 12.

The motor drive circuit 39 receives detection signals from the encoder EC, calculates the direction and amount of movement of the stage 12 and the direction and amount of movement of the carriage 15, and outputs the results to the control device 30.

The control device 30 determines whether or not the lattice point P0 is positioned directly under the nozzle N on the basis of the direction and amount of movement of the stage 12, and generates the timing signals LAT when each lattice point P0 is positioned directly under the nozzle N.

In FIG. 5, the head drive circuit 40 includes a shift register 41, a control signal generator 42, a level shifter 43, a piezoelectric element switch 44 and a first laser switch 45, a second laser switch 46 and a third laser switch 47.

The shift register 41 receives the transmission clock CLK from the control device 30 and causes the serial pattern data SI to consecutively shift.

The shift register 41 stores the serial pattern data SI of bits (180 bits in the embodiment), the number of which corresponds to the number of the nozzles N.

The control signal generator 42 receives the timing signals LAT from the control device 30 and latches serial pattern data SI stored in the shift register 41.

The control signal generator 42 converts the latched serial pattern data SI from serial to parallel form to generate parallel data of 180 bits corresponding to the nozzles N, and outputs the parallel data to the level shifter 43, the first laser switch 45, the second laser switch 46 and the third laser switch 47.

In the embodiment, the parallel data output by the control signal generator 42 is referred to as “parallel pattern data PI”.

The level shifter 43 raises the voltage level of the parallel pattern data PI from the control signal generator 42 to a drive voltage level of the piezoelectric element switch 44 to generate 180 switch signals each associated with each piezoelectric element PZ.

The piezoelectric element switch 44 has 180 switch elements each associated with each piezoelectric element PZ; the drive waveform signals COM from the control device 30 are input to an input end of each switch element, and the piezoelectric element PZ is connected to an output end of each switch element.

Each switch element outputs the drive waveform signals COM to the corresponding piezoelectric element PZ in response to switch signals associated with the corresponding piezoelectric element PZ.

Thus, when the target point P1 is positioned directly under the nozzle N, the head drive circuit 40 outputs the drive waveform signals COM to the piezoelectric element PZ corresponding to the nozzle N to cause the droplet D to be discharged toward the target point P1, i.e., to cause droplet discharge processing in accordance with the dot pattern data to be performed.

The laser switch 45 includes 180 switch elements each corresponding to each first laser source LD1.

Input to an input terminal of each switch element in the first laser switch 45 is a power supply Vcc from the control device 30, and connected to an output terminal of each switch element is the corresponding first laser source LD1.

The second laser switch 46 has 180 switch elements each corresponding to each second laser source LD2.

Input to an input terminal of each switch element in the second laser switch 46 is the power supply Vcc from the control device 30, and connected to an output terminal of each switch element is the corresponding second laser source LD2.

The third laser switch 47 has 180 switch elements each corresponding to each third laser source LD3.

Input to an input terminal of each switch element in the third laser switch 47 is the power supply Vcc from the control device 30, and connected to an output terminal of each switch element is the corresponding third laser source LD3.

Every time the lattice point P0 is positioned directly under each laser source LD1, LD2 or LD3 corresponding to each switch element, the switch element supplies drive current to the laser source LD1, LD2 or LD3, which is selected on the basis of the parallel pattern data PI, for a predetermined time.

As a result of this, every time the lattice point P0 is positioned directly under each laser source LD1, LD2 or LD3, the head drive circuit 40 causes the area of the target point P1 to be irradiated with the infrared laser light B only for a predetermined time.

In other words, the head drive circuit 40 performs drying treatment with the infrared laser light B on the basis of the dot pattern data.

Irradiation time of the infrared laser light B is set to a time until the droplet D at the target point P1 leaves the area of the infrared laser light B.

Next, a pattern formation method using the conductive ink 15 will be described below.

First, as shown in FIG. 1, the substrate S is mounted with the discharge surface Sa positioned upward on the stage 12.

When receiving the pattern data Ip from the input-output device 38, the control device 30 generates dot pattern data using the pattern data Ip.

Subsequently, the control device 30 performs sub-scanning through the motor drive circuit 39 to set each nozzle N on the main scanning path of each target point P1.

Then, the control device 30 starts main scanning of the substrate S through the motor drive circuit 39.

The control device 30 determines whether or not the target point P1 is positioned directly under the nozzle N through the motor drive circuit 39, and outputs the timing signals LAT every time each target point P1 is positioned directly under the nozzle N.

The head drive circuit 40 receives the timing signals LAT from the control device 30, and then causes the droplet D to land toward each target point P1 and applies the infrared laser light B toward the droplet D at each target point P1.

The combustion substance 15C of each droplet D receives the infrared laser light B from the laser source LD, and then starts a combustion reaction of the infrared absorption coloring matter CM and the oxygen gas CG contained in the agglomerate.

The combustion reaction of the combustion substance 15C causes a water-soluble organic matter to start a combustion reaction in a chained manner, so that each droplet D continues to be dried.

Thus, each droplet D forms a conductive pattern made of conductive fine particles at each target point P1 in accordance with the dot pattern data.

Next, effects of the first embodiment configured as described above will be described below.

(1) In the first embodiment, the conductive ink 15 includes the conductive fine particles 15A, the dispersion medium 15B in which the conductive fine particles 15A are dispersed, and the combustion substance 15C that starts a combustion reaction by receiving the infrared laser light B.

Accordingly, the droplet D made of the conductive ink 15 receives the infrared laser light B.

This causes the combustion substance 15C to start a combustion reaction.

The heat generated by this combustion reaction can accelerate the drying of the droplet D.

Thus, the droplet D made of the conductive ink 15 allows its drying efficiency to be improved.

(2) In the first embodiment, the combustion substance 15C is an agglomerate of the infrared absorption coloring matters CM that contains the oxygen gas CG, and the infrared absorption coloring matter CM starts a combustion reaction with the oxygen gas CG when receiving the infrared laser light B.

Therefore, the droplet D made of the conductive ink 15 allows its drying to be accelerated by heat generated by the combustion reaction of the infrared absorption coloring matter CM.

(3) In the first embodiment, the conductive ink 15 has a water-soluble organic matter, and a combustion reaction of the water-soluble organic matter is started by heat generated by a combustion reaction of the combustion substance 15C.

Accordingly, regarding the droplet D made of the conductive ink 15, only once combustion of the combustion substance 15C is performed, combustion of a water-soluble organic matter contained in the dispersion medium 15B can be performed in a chained manner.

Thus, the droplet D of the conductive ink 15 allows the dispersion medium 15B to be dried with reliability regardless of time during which the dispersion medium 15B is irradiated with the infrared laser light B.

(4) In the first embodiment, the droplet discharge device 10 performs discharging of the droplet D and irradiation processing with the infrared laser light B by using the common dot pattern data.

Accordingly, the droplet discharge device 10 allows each of all the discharged droplets D to be irradiated with the infrared laser light B with more reliability.

(5) In the first embodiment, every time each target point P1 is positioned directly under the laser source LD, the droplet discharge device 10 applies the infrared laser light B toward the target point P1.

Accordingly, the droplet discharge device 10 allows drying treatment to start at the same timing for all the droplets D, and therefore the wetting and spreading of the droplets D can be suppressed with uniformity.

### Second Embodiment

A second embodiment that gives a concrete form to the present invention will be described below referring to FIGS. 7A to 7C.

In the second embodiment, the combustion substance 15C of the first embodiment is changed.

Therefore, the changes will be described in detail below.

The combustion substance 15C is a self-combustion substance EM that receives the infrared laser light B from the laser source LD to start a self-combustion reaction (inner combustion reaction).

As an example of the self-combustion substance EM, nitroglycerin, 2,4,6-trinitrotoluene, 1,3,5-trinitrobenzene and picric acid can be used.

The self-combustion substance EM of the droplet D receives the infrared laser light B from the laser source LD, and starts a self-combustion reaction.

Part of heat generated by the self-combustion reaction is converted to kinetic energy of the dispersion medium 15B to accelerate drying of the dispersion medium 15B.

For example, in the case where the dispersion medium 15B of the conductive ink 15 contains water of 40 wt. % with respect to the whole of the conductive ink 15, heat of about 10 μJ per drop is required to evaporate all the water contained in the droplet D of 10 ng.

In order that all this heat is compensated for by a self-combustion reaction of nitroglycerin, nitroglycerin of 1.6 ng should be added for each droplet D.

Part of heat generated by the self-combustion reaction causes another self-combustion substance EM to start a self-combustion reaction in a chained manner.

Part of heat generated by the self-combustion reaction also causes a combustion reaction of an organic matter such as alcohols, glycols and ethers contained in the dispersion medium 15B and oxygen generated by the self-combustion reaction to start in a chained manner.

This chain of combustions consecutively accelerates drying of the dispersion medium 15B.

For example, in the case where the dispersion medium 15B of the conductive ink 15 contains water of 40 wt. % and a water-soluble organic matter (glycerin and xylitol) of 10 wt. % with respect to the whole of the conductive ink 15, a water-soluble organic matter such as alcohols, glycols and ethers contained in the droplet D generates heat of about 20 μJ by its combustion.

Therefore, regarding the droplet D, heat generated by a self-combustion reaction of the combustion substance EM causes the water-soluble organic matter to start a combustion reaction in a chained manner, thereby enabling all the water to be continuously evaporated, so that drying is completed.

Next, effects of the second embodiment configured as described above will be described below.

(6) In the second embodiment, the conductive ink 15 allows its drying to be accelerated by heat generated by a self-combustion reaction of the self-combustion substance EM.

Thus, the conductive ink 15 allows the drying efficiency of the droplet D made of the conductive ink 15 to be improved with a simple configuration including the self-combustion substance EM.

(7) In the second embodiment, the conductive ink 15 has a water-soluble organic matter, and allows heat generated by a self-combustion reaction of the self-combustion substance EM to cause a self-combustion reaction of another self-combustion substance EM and a combustion reaction of the water-soluble organic matter to start in a chained manner.

Accordingly, regarding the droplet D made of the conductive ink 15, only once combustion of one self-combustion substance EM is performed, combustion of another self-combustion substance EM and combustion of a water-soluble organic matter contained in the dispersion medium 15B can be performed in a chained manner.

Thus, the droplet D of the conductive ink 15 allows the dispersion medium 15B to be dried with reliability regardless of time during which the dispersion medium 15B is irradiated with the infrared laser light B.

### Third Embodiment

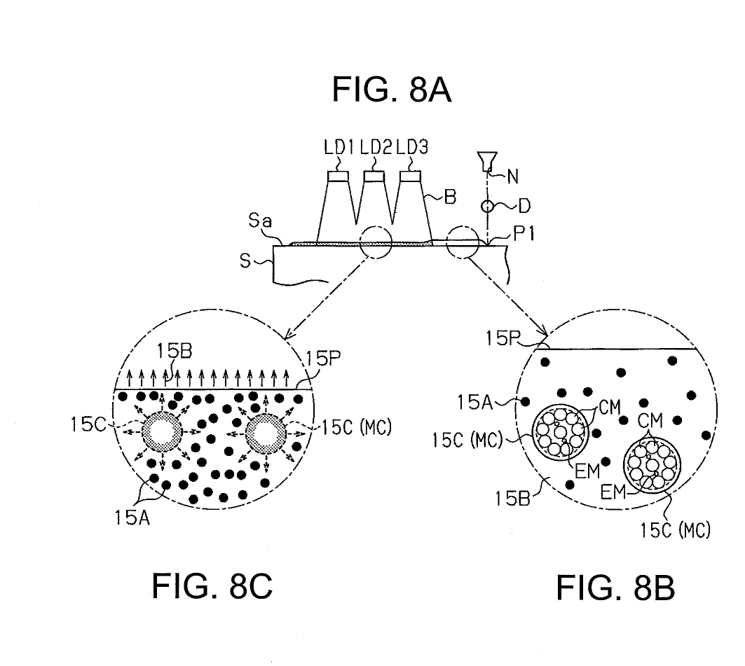

A third embodiment that gives a concrete form to the invention will be described below referring to FIGS. 8A to 8C.

In the third embodiment, the combustion substance 15C of the first embodiment is changed.

Therefore, the changes will be described in detail below.

The combustion substance 15C is a microcapsule MC that contains the infrared absorption coloring matters CM and the self-combustion substances EM.

As the infrared absorption coloring matter CM, various coloring matters shown in the first embodiment can be used.

As the self-combustion substance EM, various combustion substances shown in the second embodiment can be used, and a combustion substance can be used that receives heat from the infrared absorption coloring matter CM or the infrared laser light B of the laser source LD to start a self-combustion reaction.

An example of a manufacturing method of the microcapsule MC, a mixed liquid is generated in which xylene is mixed with 2,4,6-trinitrotoluene and azo dye.

Then, the mixed liquid is added to water containing a surface active agent, thereby generating a suspension.

A capsule material is added to the suspension to cause the capsule material to be absorbed or deposited onto the surface of a minute drop of the mixed liquid, thus generating the microcapsule MC.

The microcapsule MC of the droplet D heats the infrared absorption coloring matter CM by receiving the infrared laser light B from the laser source LD, and heat from the infrared absorption coloring matter CM causes the self-combustion substance EM to start a self-combustion reaction.

Part of heat generated by the self-combustion reaction is converted to kinetic energy of the dispersion medium 15B to accelerate drying of the dispersion medium 15B as in the second embodiment, and causes of another self-combustion substance EM to start a self-combustion reaction in a chained manner.

Part of heat generated by the self-combustion reaction also causes a combustion reaction of an organic matter such as alcohols, glycols and ethers contained in the dispersion medium 15B and oxygen generated by the self-combustion reaction to start in a chained manner.

This chain of combustions consecutively accelerates drying of the dispersion medium 15B.

Next, effects of the third embodiment configured as described above will be described below.

(8) In the third embodiment, the conductive ink 15 allows it drying to be accelerated by a self-combustion reaction of the self-combustion substance EM contained in the microcapsule MC.

Thus, the conductive ink 15 allows restrictions on compositions of the conductive fine particle 1SA and the dispersion medium 15B to be reduced in selecting the infrared absorption coloring matter CM and the self-combustion substance EM.

Therefore, the conductive ink 15 can have an extended range of application.

### Fourth Embodiment

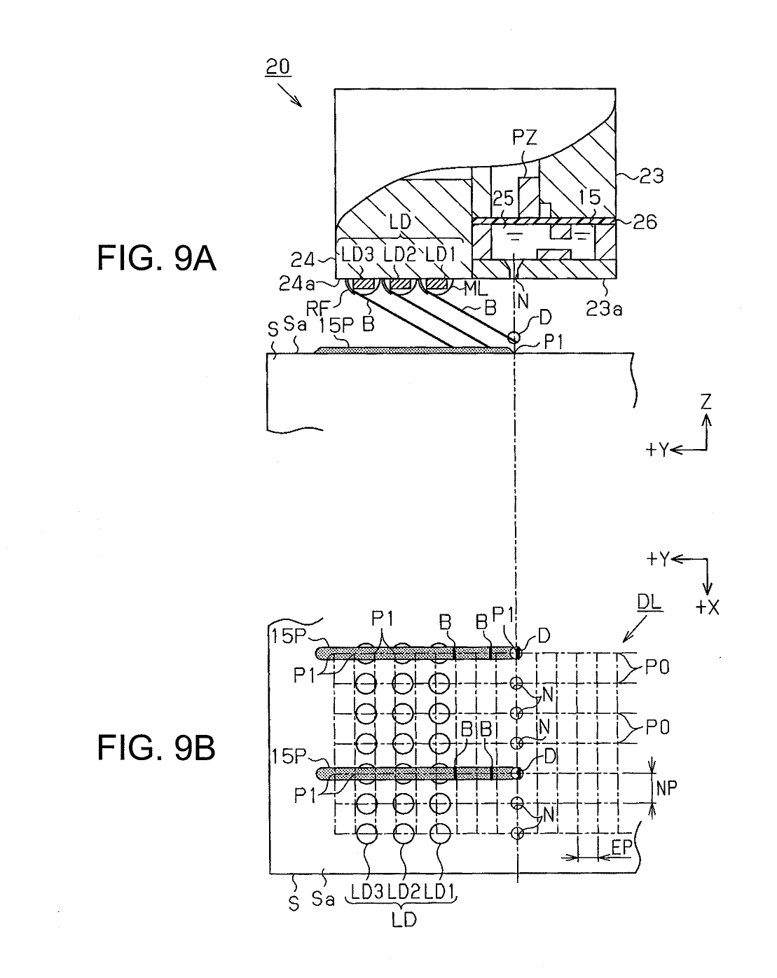

A fourth embodiment that gives a concrete form to the invention will be described below referring to FIGS. 9A and 9B.

In the fourth embodiment, each laser source LD of the first embodiment is changed.

Therefore, the changes will be described in detail below.

In FIGS. 9A and 9B, a microlens ML exhibiting a hemispherical shape is provided on an emission surface of each laser source LD, and a reflective film RF is formed on an optical surface in the +Y direction of each microlens ML.

When each laser source LD emits the infrared laser light B, each microlens ML collects the infrared laser light B while reducing the radiation angle of the infrared laser light B, and each reflective film RF reflects the infrared laser light B through the microlens ML downward in the −Y direction.

The flight path of the droplet D is irradiated with the infrared laser light B from the first laser source LD1 through the microlens ML and the reflective film RF.

The main scanning path of the droplet D is irradiated with the infrared laser light B from the second laser source LD2 and that from the third laser source LD3 each passing through the microlens ML and the reflective film RF.

When the target point P1 is directly under the nozzle N, the droplet D flying toward the target point P1 receives the infrared laser light B from the first laser source LD1 corresponding to the nozzle N during flying to cause a combustion reaction of the combustion substance 15C before the droplet D lands on the target point P1.

In other words, before each droplet D flying toward the target point P1 lands on the target point P1, drying treatment starts for the droplet D.

Next, effects of the fourth embodiment configured as described above will be described below.

(9) According to the foregoing fourth embodiment, the droplet D before landing on the target point P1 is irradiated with the infrared laser light B from the first laser source LD1.

This causes the combustion substance 15C to start a combustion reaction.

Accordingly, the droplet discharge device 10 allows drying treatment to start for the droplet D before the droplet D lands on the target point P1.

Thus, the droplet discharge device 10 allows wetting and spreading of the droplet D to be suppressed with more reliability, and thus can cope with finer design rules regarding a conductive pattern.

It should be noted that the foregoing embodiments may by changed as follows.

In the foregoing embodiments, the laser plate 24 has the first laser source LD1, the second laser source LD2 and the third laser source LD3 along the +Y direction.

The laser plate 24 is not limited to this, but may have, e.g., a configuration having the first laser source LD1 only, and needs only to have a configuration in which a combustion reaction of the combustion substance 15C is started by the infrared laser light B from the laser source LD.

In the foregoing embodiments, the conductive ink 15 needs only to have a configuration having at least one of an agglomerate of the first embodiment, the self-combustion substance EM and a microcapsule of the third embodiment.

In the foregoing embodiments, the droplet discharge head 20 is a head of a piezoelectric element drive system.

However, the droplet discharge head is not limited to this, and may be a droplet discharge head of a resistance heating system or an electrostatic drive system.

In the foregoing embodiments, the light to be applied to droplets is embodied as laser light from a VCSEL source.

However, the light is not limited to this, and may be laser light from a semiconductor laser or light from a light-emitting diode (LED).

In the foregoing embodiments, the conductive ink 15 is described as water-based ink.

However, the conductive ink 15 is not limited to this, and may be embodied as organic solvent ink.

For example, the conductive ink 15 may be ink in which microcapsules are dispersed in metal nano fine particle-dispersed ink containing tetradecan as the main solvent.

The entire disclosure of Japanese Patent Application No. 2007-250787, filed Sep. 27, 2007 is expressly incorporated by reference herein.

What is claimed is:

1. An ink composition comprising:
a conductive fine particle;
a dispersion medium in which the conductive fine particle is dispersed; and
a combustion substance that starts a combustion reaction by receiving light.

2. The ink composition according to claim 1, wherein:
the light is infrared laser light;
the combustion substance is an agglomerate of a coloring matter containing oxygen; and
the coloring matter that starts a combustion reaction with the oxygen by receiving the infrared laser light.

3. The ink composition according to claim 1, wherein:
the light is laser light; and
the combustion substance has a self-combustion substance that starts a self-combustion reaction by receiving the laser light.

4. The ink composition according to claim 1, wherein:
the light is infrared laser light; and
the combustion substance has a microcapsule, the microcapsule containing:
a coloring matter that converts the infrared laser to heat; and
a self-combustion substance that starts a self-combustion reaction by receiving heat from the coloring matter.

5. The ink composition according to claim 1, wherein the dispersion medium has any one organic matter selected from a group including alcohols, glycols and ethers that start a combustion reaction by heat generated by the combustion reaction of the combustion substance.

6. A pattern formation method comprising:
discharging an ink composition as a droplet to an object, the ink composition including a conductive fine particle, a dispersion medium, and a combustion substance that starts a combustion reaction by receiving light; and
applying light to the droplet to cause the combustion substance to start a combustion reaction, thereby drying the droplet to form a conductive pattern on the object.

7. The pattern formation method according to claim 6, wherein the droplet before landing on the object is irradiated with light, causing the combustion substance to start a combustion reaction.

8. A droplet discharge device comprising:
an ink tank that stores an ink composition, the ink composition including a conductive fine particle, a dispersion medium, and a combustion substance that starts a combustion reaction by receiving light;
a droplet discharge head that receives the ink composition derived from the ink tank and discharges the ink composition as a droplet to an object; and
an irradiation portion that applies the light to the droplet.

9. The droplet discharge device according to claim 8, wherein the irradiation portion applies the light the droplet before landing on the object.
